(19) United States
(12) Patent Application Publication
(10) Pub. No.: US 2008/0154612 A1
(43) Pub. Date: Jun. 26, 2008

(54) Local storage and use of search results for voice-enabled mobile communications devices

(75) Inventors: Gunnar Evermann, Boston, MA (US); Daniel L. Roth, Boston, MA (US); Laurence S. Gillick, Newton, MA (US); James Coughlin, Ipswich, MA (US)

Correspondence Address: WILMERHALE/BOSTON, 60 STATE STREET, BOSTON, MA, 02109, US

(73) Assignee: Voice Signal Technologies, Inc., Woburn, MA (US)

(21) Appl. No.: 11/673,997

(22) Filed: Feb. 12, 2007

Related U.S. Application Data
(63) Continuation of application No. 11/673,341, filed on Feb. 9, 2007.
(60) Provisional application No. 60/877,146, filed on Dec. 26, 2006.

(51) Int. Cl. G10L 11/00

(52) U.S. Cl. 704/275

(57) ABSTRACT

A method implemented on a mobile device that includes speech recognition functionality involves: receiving an utterance from a user of the mobile device, the utterance including a spoken search request; recognizing that the utterance includes a spoken search request; sending a representation of the spoken search request to a remote server over a wireless data connection; receiving search results over the wireless data connection that are responsive to the search request; storing the results on the mobile device; receiving a subsequent search request; performing a subsequent search responsive to the subsequent search request to generate subsequent search results, the subsequent search including searching the stored search results; and presenting the subsequent results on the mobile device. The method also involves indexing the stored results according to the user's search request, enhancing the device's ability to recognize frequently requested searches, and pre-loading the device with results corresponding to certain frequently requested searches.

### CROSS-REFERENCE TO RELATED APPLICATIONS

This application is a continuation of application Ser. No. 11/673,341, filed Feb. 9, 2007, and claims the benefit of U.S. Provisional Application No. 60/877,146, filed Dec. 26, 2006, both of which are incorporated herein by reference.

### TECHNICAL FIELD

This invention relates generally to wireless communication devices with speech recognition capabilities.

### BACKGROUND

In addition to serving as wireless telephones for making phone calls, wireless communication devices, such as cell phones, can enable users to obtain access to information. Typically, such phones offer the user access to a web browser to access the Internet. But accessing information using a cell phone can be awkward, unreliable, slow, and costly.

Most cell phones have small keypads that are principally designed for keying in phone numbers or short SMS messages. This makes it cumbersome for a user to enter a request for information. In addition, most cell phones have a small display, which constrains the quality and quantity of information that can be displayed. Furthermore, access to the World Wide Web (Web) usually involves navigating through menu hierarchies before the user can access the Web browser application on his phone.

Since cell phones access information via a mobile carrier network, reliability can become a problem when a user travels outside the range of their mobile carrier's signal, such as in a tunnel or to a remote location. Slow response to information requests can also be frustrating for the user. Such slow responses stem, in part, from inherent data transmission latency associated with each menu choice. Cost can also be an issue because the user typically uses billed “air time” for the duration of the information access session.

### SUMMARY OF THE INVENTION

The described embodiment stores on a voice-enabled mobile communications device the results received by the device in response to certain voice-mediated search requests. Subsequent search requests may then be retrieved from locally stored information, without the need for the device to connect to an external resource.

In general, in one aspect, a method implemented on a mobile device that includes speech recognition functionality involves: receiving an utterance from a user of the mobile device, the utterance including a spoken search request; using the speech recognition functionality to recognize that the utterance includes a spoken search request; sending a representation of the spoken search request to a remote server over a wireless data connection; receiving search results over the wireless data connection that are responsive to the search request; storing the search results on the mobile device; receiving a subsequent search request; performing a subsequent search responsive to the subsequent search request to generate subsequent search results, the subsequent search including searching the stored search results; and presenting the subsequent search results on the mobile device.

The method further involves receiving a plurality of search requests, and using the plurality of search requests to establish a popularity of each of the plurality of search requests. The described embodiment also includes one or more of the following actions: receiving speech recognition information to enhance the ability of the speech recognition functionality to recognize the subsequent search when the subsequent search request is a spoken search request and when the subsequent search request corresponds to the last-received search request of the plurality of search requests, and storing the received speech recognition information on the mobile device; for a last-received search request of the plurality of search requests, determining whether the last-received search request exceeds a predetermined threshold popularity of search request, and if the last-received search request exceeds the predetermined threshold popularity of search request, storing search results corresponding to the last-received search request on the mobile device; if the last-received search request exceeds the predetermined threshold popularity, receiving speech recognition information to enhance the ability of the speech recognition functionality to recognize the last-received search request when the last-received search request is a spoken search request, and storing the received speech recognition information on the mobile device; prior to receiving the subsequent search request, receiving information responsive to the subsequent search request; storing the received information on the mobile device to enhance the responsiveness of the mobile device to the subsequent search request, the subsequent search including searching the stored received information; the received information responsive to the subsequent search request is time-sensitive, and the enhanced responsiveness of the mobile device to the subsequent search request involves enhancing the ability of the mobile device to present up-to-date search results; and retrieving subsequent search results from stored search results.

Storing the search results involves assigning the search to a category and generating the subsequent search results includes retrieving stored search results that have been assigned to the category. The category may correspond to the spoken search request, to a geographical location associated with a stored search result, or to a type of business associated with a stored search result. Search results may be assigned to a more than one category.

The subsequent search request can be a spoken search request and be recognized using the speech recognition functionality. Alternatively, if the mobile device is equipped with input keys and/or hardware that supports a graphical user interface, the subsequent search can be received via input keys and/or the graphical user interface.

In general, in another aspect, an embodiment includes a mobile device that includes a processor system and memory storing code which, when executed by the processor system, causes the mobile device to perform the functions of: receiving an utterance from a user of the mobile device, the utterance including a spoken search request; using speech recognition functionality to recognize that the utterance includes a spoken search request; sending a representation of the spoken search request to a remote server over a wireless data connection; receiving search results over the wireless data connection that are responsive to the search request; storing the search results on the mobile device; receiving a subsequent search request; performing a subsequent search responsive to the subsequent search request to generate subsequent search results, the subsequent search including searching the stored search results; and presenting the subsequent search results on the mobile device.

The code, when executed, may further cause the mobile device to retrieve the subsequent search results from the stored search results, assign at least one of the stored search results to a category and generate the subsequent search results by retrieving stored search results that have been assigned to a category. The category may correspond to a spoken search request, a geographical location, or a type of business associated with a search result. Stored search results may be assigned to more than one category.

The mobile device may receive the subsequent search request as an utterance from the user, and the code when executed on the processor system causes the mobile device to recognize spoken search request within the utterance. The mobile device includes input keys and the code, when executed on the processor system, causes the mobile device to receive the subsequent search request via the input keys. The mobile device includes hardware that supports a graphical user interface and the code when executed on the processor system causes the mobile device to receive the subsequent search request via graphical user interface.

### BRIEF DESCRIPTION OF THE DRAWINGS

FIG. 1 is a high-level block diagram of an architecture that supports the functionality described herein.

FIG. 2 is an illustration of a mobile device displaying functionality described herein.

FIG. 3 is an illustration of a search result displayed in response to a search request.

FIG. 4 illustrates an example of a grammar pathway available to a search command.

FIG. 5 illustrates an example of a displayed search result.

FIG. 6 illustrates a series of screen displays of a mobile device that result from recognition of a received search command.

FIG. 7 is a high-level block diagram of a mobile device on which the functionality described herein can be implemented.

### DETAILED DESCRIPTION

The described embodiment is a mobile device and server system that provides a user of the mobile device with voice-mediated access to a wide range of information, such as directory assistance, financial data, or to search the Web. In general, this information is not stored on the device itself, but is stored on any server or other device to which the mobile device has access either via predetermined relationship, or via a public access network, such as the Internet. The system allows the user to activate this functionality in a single step by pressing a button that launches voice-mediated search application software on the device or, alternatively, by using other input means supported by the mobile device. Execution of the voice-mediated search application software causes the device to display a main voice command menu that includes voice-mediated search commands along with voice command and control commands. The user invokes the device's search functionality by uttering a search command, such as, for example “Directory Assistance.” The device recognizes the command, and, for certain search commands, elicits further information from the user. In the directory assistance example, it asks “What city and state?” and “What listing?” The search application then opens a wireless data connection to a transaction server, and sends it a representation of the user's spoken answers. The transaction server receives the audio from the device, and forwards it to a speech recognizer, which converts the audio into text and returns it to the transaction server. The transaction server then forwards the user's information request, now in text form, to an appropriately selected content provider. The content provider searches for and retrieves the requested information, and sends its search results back to the transaction server. The transaction server then processes the search results and sends the results along with the user's search request and information about the user to one or more advertising providers. These providers offer advertisements back to the transaction server, which selects optimally targeted advertisements to combine with the search results. The transaction server then sends search results and advertisements to the mobile device. The device's voice-mediated search software displays the results to the user as text, graphics, and video and, optionally as audio output of synthesized speech, sounds, or music.

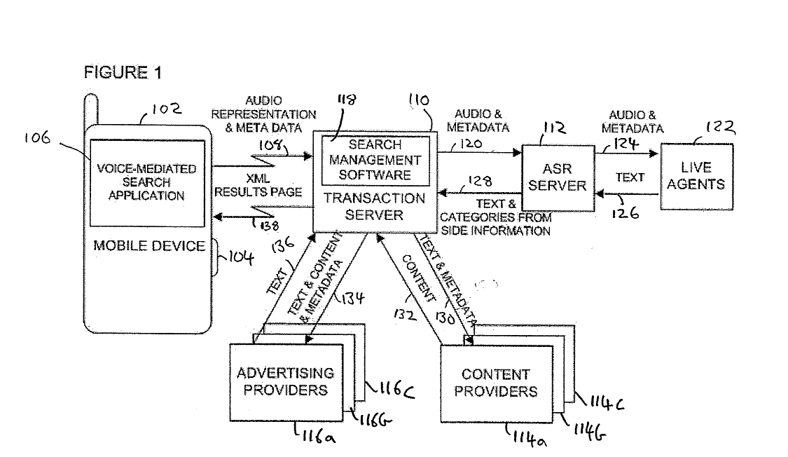

The block diagram and information flows shown in FIG. 1 help describe a particular embodiment of the system. We will describe the voice-mediated search application running on the device. Following that, we will describe the application on the transaction server and how it interacts with the speech recognizer, the content providers, and the advertising providers. We will also describe how the system takes advantage of metadata that is explicitly available from the mobile device as well as side information that is implicitly available from the audio signal captured by the mobile device from the user's utterances.

### The Mobile Device

Mobile device 102 (FIG. 1) is a personal wireless communication device, such as a cellular (cell) phone, that can receive audio input from a user. The device includes a microprocessor, static memory, such as flash memory, and a display for displaying text and graphics. The device can also support additional functionality, such as email, SMS messaging, calendar, address book, and camera. We describe mobile device 102 in more detail in the section below entitled “Hardware Platform.”

Device 102 includes voice application software that, when invoked, confers voice activation capability on the device. When the device is powered on, it displays an “idle screen,” that includes date, time, and a means of reaching a command menu. At this point, the device has no voice recognition capability. From the idle screen, the user invokes the voice application software by pressing dedicated voice activation button 104, or by using one or more of the keys on a device that lacks a dedicated button. The device and the voice application are designed so that the user can always voice-activate the device with a single press of button 104, or by other straightforward actions, such as by flipping open a clamshell phone, using one or more standard key presses, or via other input means supported by the mobile device.

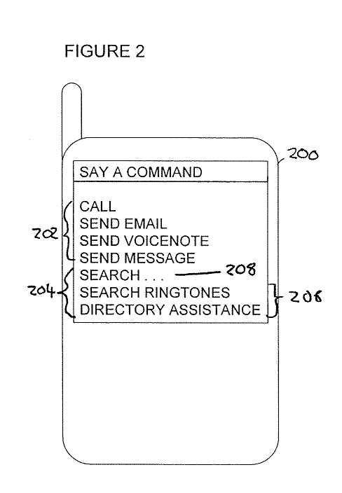

When the user launches the voice application software, it causes device 102 to display main voice command menu 200 (FIG. 2), and activates the device's ability to receive, recognize, and act upon voice commands, i.e., to become voice-activated. Main voice command menu includes a set of voice commands, called “gate commands,” because they are available to the user “right out of the gate,” without the need to navigate through additional menus. Each gate command can be activated by an utterance spoken by the user. This functionality is provided by speech recognition software running on mobile device 102. For command menu 200 of FIG. 2, device 102 has speech recognition software that recognizes the utterances “call,” “send email,” “send voice note,” “search ringtones,” “directory assistance,” and “search.” Device 102 can recognize these utterances with a high confidence level because its speech recognizer needs to recognize only one of a small number of allowed utterances.

Main voice command menu 200 includes “command and control” commands 202 for controlling and operating device 102, such as commands for placing a phone call, sending an email, or sending a text message. Menu 200 also includes search commands 204. As shown in FIG. 2, search commands 204 are integrated with command and control commands 202 in main voice command menu 200. When mobile device 102 recognizes one of search commands 204, voice application software on device 102 launches voice-mediated search application (VMSA) software 106.

VMSA 106 implements the mobile search functionality of device 106. This includes: determining what type of search the user is requesting; managing the search-related speech recognition on the device; opening an IP connection to a remote server, if needed, to fulfill the search request; processing and sending the search query over the connection to the server; maintaining a log of the user's actions taken in response to received search results and advertisements; and receiving and displaying the search results. These functions are described in the paragraphs that follow.

When the user utters one of the search commands, device 102 performs the speech recognition for the command words listed on main voice command menu 200. For example, for search commands 204, the device recognizes the utterances “search ringtones,” “directory assistance,” and “search.” The voice application software on the device determines that the user is making a mobile search request, and activates VMSA 106. The subsequent actions that VMSA 106 takes depend on the type of search request that the user has made. The main voice command menu includes two types of voice search commands—guided search commands 206, such as “search ringtones” and “directory assistance,” and the open search command “search” 208. We describe each in turn next.

Guided search commands 206 uses voice and text prompts to guide the user through a directed dialog in order to elicit the information required in order to fulfill his search for information. For example, when the user says “search ringtones,” the device responds with a spoken and displayed prompt “what artist?” The user then speaks the name of the artist. The device captures the user's spoken answer, transmits it to remote servers that recognize the speech and retrieve the available ring tones that correspond to the user's selected artist. The servers return the results to device 102, which then displays one or more screens of ringtone choices. The user can select a ringtone, and the device then downloads his selection to the device.

When VMSA 106 recognizes that the user has requested one of guided search commands 106, the user has explicitly told the device what category of search he desires. The mobile search system exploits this knowledge in a number of ways in order to improve the quality of its response to the user's request, and also to maximize monetization of the transaction. We describe these actions below in connection with the transaction server. The actions that take place on device 102 that are determined by the search category include the selection of a category-specific search grammar for guiding the search dialog, and special software to display and/or speak the results of the search. In addition to the two commands 206 referred to above, other examples of guided searches include searches for sports results, weather conditions and forecasts, and news headlines.

When mobile device 102 is shipped from the factory, it is provisioned with a factory set of guided search commands. In the example shown in FIG. 2, two guided search commands (204) were shipped with the phone. Remote servers can add additional gate search commands to the device after it has been shipped by sending new search command dialogs, speech recognition data, and other necessary software over the air (OTA) to the device. The additional OTA commands can be requested by the user, or can be sent automatically by the provider of mobile search services as an update to the device's VMSA 106. In the former case, the user determines when he receives the additional gate commands. In the latter case, the updating is typically part of a service agreement between the user of the mobile device and the mobile search provider, and takes place at intervals and times of day that are determined by the provider.

Should the user wish to prune his list of gate search commands, he can delete one or more such commands from the device's main voice command menu 200. Removal of gate commands can also be performed by the mobile search provider as part of a service agreement of the kind mentioned above. Removal of obsolete gate commands can help simplify the user's voice-mediated search menu and help the user to access the most up-to-date search functionality on his mobile device.

In contrast to the guided search commands, open search command 208 is invoked when the user speaks a single, continuous utterance starting with the word “search.” Device 102 recognizes the word “search” and sends the utterance that follows to one or more remote servers for speech recognition and further handling of the search query. Unlike guided search, open search does not prompt the user with a dialog requesting further search information. As such, the open search command serves as an “expert” search mode, where the user already knows what information the system needs in order to return the desired result. For such a user, being able to complete a search request with a single utterance is convenient and fast because there is no need to pause for guided dialog prompts, or suffer any delays or system latencies associated with the multiple steps of the guided dialog.

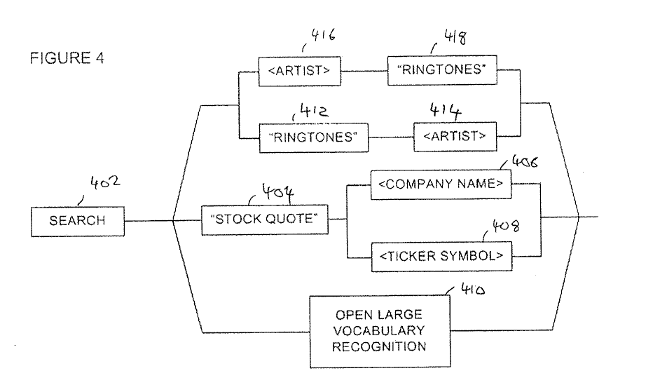

Open search command 208 also serves to offer almost unlimited search capability to the device user. Rather than being tied to the information searches that are targeted by guided search commands 206, open search allows the user to utter any search request without restriction. As discussed in detail below, a remote automatic speech recognition server checks an open search command utterance to see if it can classify it as one of the categories represented by a guided search, or as any one of a number of search categories known to a remote server. If it is unable to identify the user's open search request as belonging to a known category, the remote servers default to a true open search procedure, which invokes a large vocabulary speech recognizer located on a remote automatic speech recognition server to generate text that the system forwards to a general-purpose content provider. FIG. 4 illustrates the various grammar pathways available to the open search command. These are discussed below in connection with the transaction server.

Within each mobile search dialog, VMSA 106 running on device 102 performs some of the speech recognition task locally, and passes on the remainder to a remote server. As mentioned above, the device recognizes the gate search commands locally without the need for any external assistance. In addition, the VMSA has the capacity to recognize whether the user of the device repeats the same voice search queries frequently, and to train itself so as to recognize such queries locally. The number of such locally recognizable voice queries increases as a function of the processing power and memory capacity of device 102. VMSA 106 also has the ability to add to its speech recognition capability by receiving from a remote server speech recognition information that enables it to perform local speech recognition of complete search requests or of parts of spoken search requests. As described below in the section on Personal Yellow Pages, it receives such capability for certain frequent search requests.

Although the speech recognizer on mobile device 102 cannot match the vocabulary, accuracy, and speed of a dedicated large vocabulary automatic speech recognition server, it functions in an environment where it is often possible to simplify the speech recognition task either by limiting the number of allowed utterances or by making predictions based on the way the user has used his device in the past. In general, it is desirable to perform as much speech recognition as possible on device 102 without invoking the assistance of a remote recognition server. There are two main reasons for this. First, speech that is recognized locally is not subject to delays that occur when the device sends speech over a wireless connection to one or more remote servers for processing, and receives the recognized text back over the wireless connection. Second, local speech recognition reduces the computational load placed on remote recognition servers, and takes advantage of local processing power on the mobile device. With hundreds of millions of mobile devices, each with its own processing capacity, there is a considerable saving in the required server speech recognition capacity for each increment in locally performed speech recognition.

When VMSA 106 determines that it needs a data connection to a remote server in order to fulfill a mobile voice search command, it causes device 102 to send a message via the wireless carrier to open connection 108 using the TCP/IP protocol to transaction server 110 (See FIG. 1), which is specified with a particular IP address. The IP address of the transaction server is stored within VMSA 106 when device 102 is shipped from the factory. Transaction server 110 is operated by a voice search provider. The voice search provider can update the IP address of transaction server 110 over the air to device 102 at any time.

Although data connection 108 is a wireless connection when the device is not connected by other means to transaction server 110 or to other remote resources, the connection can be a wired or fixed connection when such connections are available to the mobile device. For example, when the user is at home or in an office, he can physically connect mobile device 102 to a data connection, such as a local area network, and achieve higher connection speeds than those typically offered by wireless carriers.

When VMSA 106 determines that the device needs to transmit audio information to transaction server 110 in order to fulfill a mobile search request, it performs signal-processing functions on the audio captured by device 102 to extract speech features that are a compact representation of the user's search utterance. The representation includes any of the speech representations that are well known in the field of speech recognition, such as, for example, the mel frequency cepstrum coefficients and linear predictive coding. It also collects other information relating to the device and the user, which we refer to as metadata, and transmits both the speech features and the metadata over data connection 108 to transaction server 110.

Metadata is of two types: explicit and implicit. Explicit metadata includes data such as: the make and model of device 102; a unique identifier of the user of the device; and the geographical location of the device, if that is available from built-in GPS functionality. Implicit metadata, which we refer to as side information, is contained within the audio captured by the phone. Side information constitutes aspects of the captured audio stream that are not essential to speech recognition. Examples of side information contained within the audio stream include information that corresponds to the user's gender, age range, accent, dialect, and emotional state. The side information also includes information about the environment in which the user is operating the mobile device. For example, the user could be operating the phone inside a vehicle, in a quiet location such as in a home or a quiet office or in a noisy location. Noisy locations include offices with nearby coworkers or noise-producing machinery such as printers and conditioning systems, and public locations such as stores, shopping malls, railway stations, and airports. Side information is preserved when the device performs its signal-processing functions, and is therefore contained within the speech features that the mobile device transmits over connection 108 to transaction processor 110.

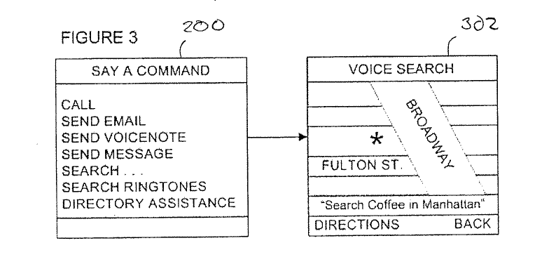

When transaction server 110 returns the voice search results and associated advertising content to mobile device 102, VMSA 106 receives the information and presents it to the user as text and graphics on the device's display, and also, where appropriate, as an audio or a video message. FIG. 3 shows an example of a displayed result 302 in response to an open voice search command: “Search coffee in Manhattan.” Result 302 includes a map and a clickable link for further information. If the user clicks on a link, VMSA 106 also handles the connection of the mobile device to the remote resource that is pointed to by the link. VMSA 106 further sends a log to the transaction server of the user's connection to the remote resource. We will describe this after the section describing the functions performed by the transaction server.

### System Architecture

Transaction server 110 serves as the hub of the voice-mediated mobile search service. It communicates with one or more speech recognition servers 112 (FIG. 1), one or more content providers 114a, 114b, 114c, and with one or more advertising providers 116a, 116b, 116c. It runs voice search management software 118 that is designed to optimize the quality of the content of information that is retrieved from content providers in response to the mobile device user's search request, and at the same time to maximize revenues for the parties involved. It achieves this by: using both the extracted speech features and the metadata to optimize the accuracy of the voice search query speech recognition; attempting to place each search into a predetermined category; exploiting any identified search category information, search results, and metadata to optimize the responsiveness of the search results it sends to the mobile device and to optimize the targeting of advertisements to the user; and to format results for display on a mobile, sound-enabled device.

In general, search management software 118 running on transaction server 110 receives audio and metadata from mobile device 102 via connection 108, and passes the audio and metadata on to automatic speech recognizer (ASR) server 112 via connection 120. ASR Server 112 performs speech recognition on the audio, using the metadata when it can in order to improve recognition accuracy. ASR server optionally forwards the audio and metadata on to live (human) agents 122 via connection 124. Live agents return text and categories derived from side information to ASR server 112 via connection 128. ASR server 112 returns text and categories derived from side information to transaction server 110 via connection 126. Search management software 118 uses metadata and knowledge of the search category to select one or more content providers 114a, b, c to service the search request, and sends them the text search query and metadata over connection 130. Content providers 114a,b,c retrieve the requested content, and return the results to transaction server 110 over connection 132. The transaction server selects and prioritizes the received content by using the metadata and commerce information, such as special offers or time-sensitive opportunities. The transaction server also has the option to send search results, the search query, metadata, and user history information to one or more advertising providers 116a, b, c over connection 134. The advertising providers return potential advertisements and pricing information back to the transaction server over connection 136. The transaction server selects an advertisement, combines it with the search results in an appropriate format, and transmits the results and advertisement over connection 138 to mobile device 102. VMSA 106 then receives the results and presents them to the user. We now describe these steps in detail.

Although data connection 138 is a wireless connection when mobile device 102 is not connected by other means to transaction server 110 or to other remote resources, the connection can be a wired or fixed connection when such connections are available to the mobile device. For example, when the user is at home or in an office, he can physically connect mobile device 102 to a data connection, such as a local area network, and achieve higher connection speeds than those typically offered by wireless carriers.

As described above, when VMSA 106 needs to invoke resources outside the device itself in order to fulfill a voice-mediated search query, it opens data connection 108 and sends speech features and metadata to transaction server 110. It also lets the transaction server know which kind of voice search command it has recognized, i.e., whether it is one of guided search commands 206, or open search command 208. The transaction server forwards the voice search command type, as well as the speech features to ASR server 112.

### Automatic Speech Recognition Server

### Guided Search Commands

When ASR server 112 receives audio and metadata associated with one of the guided search commands 208, it already knows the category of the search. This information specifies the guided dialog, and the database of allowed responses for each prompt. For example, the “SEARCH RINGTONES” command is followed by a “WHAT ARTIST?” prompt, and the subsequent speech is expected to be an artist name. If the user says “Madonna,” the ASR server attempts to recognize the received audio against its database of artists for which ringtones are available. The ASR server obtain a high recognition confidence measure because it only matches against a small vocabulary. Similarly, if the ASR receives audio associated with a guided dialog in a “DIRECTORY ASSISTANCE” command followed by a “WHAT STATE?” prompt, it searches for matches in its database of state names, and after the prompt “WHAT CITY” it uses a database of city names in the identified state.

Although ASR server 112 can usually achieve a high confidence measure when recognizing speech that is uttered in response to a guided search prompt, it can encounter difficulties in special circumstances. For example, the user may not speak clearly, or may have a strong accent. Background noise, such as passing airplane, might obscure the speech. In these situations, ASR server 112 may be able to improve the confidence measure of speech recognition by using the metadata. For example, explicit metadata that contains the home address of the user may bias recognition in favor of a listing near the city where he resides. If the ASR has access to the phone's geographic location via GPS, it might also be able to use that information to improve recognition accuracy of a spoken city or state name.

### Open Search Command

When the user speaks a single utterance starting with the word “search,” he invokes open search command 208. ASR Server 112 receives the speech features corresponding to a continuous utterance corresponding to a complete spoken search request via transaction server 110. In contrast to guided search, the ASR server receives no explicit search category information.

In general, the open recognizer automatically attempts to determine whether an open search belongs to a predetermined search category. It does this because several important benefits accrue from knowing the search category. First, ASR Server 112 can use one of the guided search grammars, which improves its speech recognition accuracy over what it could achieve using a general purpose large vocabulary recognizer where it would not be able to search a limited database of allowed responses. Second, the ASR Server returns the search category to transaction server 110, which can then determine the one or more content providers that best suit that search category, as described in detail below. This helps to optimize the quality and responsiveness of the search results. Third, advertising providers 116 are better able to target their advertisements to a mobile device user when they know what category of search he has requested and what type of results he is going to receive. Fourth, knowledge of the search category allows transaction server 110 to perform category-specific extraction of results from selected content providers 114, and custom-format these results for rendering on mobile device 102.

Predetermined speech categories include, but are not limited to those categories that correspond to guided gate search commands 206. Transaction server 110 and ASR Server 112 are configured to handle up to about one hundred predetermined search categories. Each category is associated with a speech recognition grammar, one or more suitable content providers and advertising providers, and custom result extraction and rendering software on the transaction server, as described in the previous paragraph. Examples of predetermined categories include stock quotes, weather forecasts, and sports news. Predetermined search categories can be added or removed from the transaction server and ASR server without the need to communicate with mobile device 102. Thus the user's ability to obtain quality results from automatic category detection in open searches can be enhanced remotely without the user being aware of the change and without the need for device 102 to download additional gate commands or search dialogs over the air.

FIG. 4 shows an example of how ASR Server 112 parses open search commands. As described above, when the user says the word “SEARCH” 402 as the first word in a continuous utterance, device 102 conveys the invocation of open search command 208 to ASR Server 112 via transaction server 110. The ASR Server then attempts to match the utterance against all of its predetermined category grammars, pruning the searches as appropriate depending on quality of fit measures. For example, if the search utterance is “SEARCH STOCKQUOTE MOTOROLA” the ASR obtains a high “score” that is a measure of the quality of fit for the pathway that traverses from 402 to 404 to 406. The ASR also uses the open large vocabulary recognizer 410 to recognize the utterance, and determines a second open recognizer quality of fit score. Since open recognizer 410 always permits more matches for each word than a category-specific grammar, open recognizer scores are generally higher than category-specific grammar scores. The system selects the open recognizer's result only if open recognizer's score exceeds that of the highest-scoring category-specific grammar by more than a tunable threshold amount. An operator performs the tuning empirically to minimize the number of category misclassifications of a set of open search utterances from users using their mobile devices in normal conditions.

FIG. 4 also shows how open search command 208 handles searches that correspond to guided gate search commands. For example, if the user says “SEARCH RINGTONES MADONNA” in a single utterance, VMSA 106 invokes open search command 208, instead of the guided search command “SEARCH RINGTONES” because the latter requires a pause after the word “RINGTONES.” The ASR Server obtains a high score by traversing the grammar pathway from 402 to 412 to 414, and identifies the search as belonging to the search ringtone category. The open recognizer also offers alternative grammars for a given category. For example, if the user says “SEARCH MADONNA RINGTONES” the highest-scoring category-specific pathway would traverse 402, to 416, to 418, and achieve the same result. Thus the open search command provides the same functionality as the guided search commands, but offers more flexibility of word order, and the convenience of speaking the search request in a single continuous utterance.

In the described embodiment, the open recognizer 410 includes a vocabulary of about 50,000 words and uses a language model to help improve speech recognition accuracy. The open recognizer serves as a fall-back recognizer when none of the predetermined search categories produces a high enough score, or, in other words, when the search category is not recognized by the system. Searches will not be recognized by the system even if they pertain to one of the predetermined categories if users say a word that is not covered by the grammar. For example, if a user says “STOCKPRICE” instead of “STOCKQUOTE,” the category-specific grammar produces a low score, but large vocabulary recognizer 110 performs as an effective backup. Another situation in which a search whose category should be recognized but is missed arises when the user says words that are not included in the database of allowed responses. For example, if a user says “SEARCH BARS IN LAS VEGAS NEW MEXICO,” local business listings category grammar will produce a poor score because the database of cities in New Mexico does not include Las Vegas. However, large vocabulary recognizer 410 correctly recognizes the words and when the text is returned to the transaction server and passed to one of content providers 114a, such as Google, the appropriate results for this less well-known town will be returned. Large vocabulary recognizer 410 is also required when a search does not pertain to any of the predetermined categories.

The system also has the ability to forward poorly recognized open searches to live human agents 122 (FIG. 1) over pathway 124 from ASR Server 112. The live agents listen to the audio and side information, and key in the corresponding text and categories, such as gender, derived from the audio stream.

Users generally invoke voice-mediated mobile searches only for location-related or time-critical types of search requests because mobile devices have much more limited display capabilities than laptops or desktop computers. This narrower range of likely searches increases the probability that ASR Server 112 will be able to determine the category of an open search, and therefore that the system will be able to deliver high quality results to the user. Furthermore, the system can maintain statistics of the kinds of searches requested, and can continually add categories that correspond to the most commonly requested search types.

When performing open search command speech recognition, ASR 112 uses metadata to improve recognition accuracy. As described above for guided searches, explicit metadata that tells the system where device 102 is located, or that provides details about the user's home or work address, or profession can serve to bias speech recognition results. For example, when ASR Server recognizes an utterance as “SEARCH BOSTON HOTELS” or “SEARCH AUSTIN HOTELS” with nearly equal scores, location metadata that indicates the user is in Boston can help the recognizer to make the more likely choice.

ASR Server 112 also includes software that extracts the side information contained within the signal it receives via transaction server 110 from mobile device 102. Side information is preserved when VMSA 106 running on mobile device 102 performs its signal-processing functions, and is therefore contained within the speech features that the mobile device transmits over connection 108 to transaction processor 110. ASR Server 112 uses the side information it extracts from the received signal to categorize the mobile device user and also, if the side information permits, to categorize the environment in which the user is operating the mobile device. We describe this in more detail in the following paragraphs.

The user categories include gender, an age range, accent, dialect, and the emotional state of the user. The speaker's gender affects the spectral distribution within the received signal. Similarly, the voice characteristics of a young speaker are sufficiently different from those of an older speaker that ASR software can determine an age category that is at least able to distinguish a teenage or younger user from an older user. Accent categories refer to categories of user who are not using their native tongue, and whose speech retains an accent characteristic of the their native tongue. For example, such categories include users speaking English with a Spanish or a Japanese accent. Accent categories also include categories for regional speech variations for users even when they are speaking their native tongue. For example, an American Southerner speaking in English can be categorized as from the South of The United States, and a New Yorker speaking with a New York accent can be categorized as such.

Dialect categories refer to categories of user who speak their native tongue in a manner characteristic of their place of origin. Dialect categories can overlap with accent categories to reveal a place of origin, but they can also be indicative of a user's social class. For example, in Britain, a user who speaks Oxford English can be placed in a category of a middle class user, while a user who speaks with a Cockney accent or other regional British accent is placed in a working class category.

As mentioned above, side information can sometimes permit the server to categorize the environment in which the user is operating the mobile device. One such category is the inside of a vehicle. For example, if the user is speaking while driving a car, the side information can contain information characteristic of engine, road, tire, and wind noise. Another such category is the ambient noise level. For example if there is little background noise in the received signal, the ASR server assigns the user to a quiet environment category, which can be indicative of an indoor location, such as a home or a quiet office. If the user is in a noisy environment and the side information includes characteristics of other voices, such as those from nearby coworkers, the ASR server assigns the user to an office environment category. Noise from office machinery, such as printers and telephones, also causes the ASR server to assign the user to an office environment. Other user environment categories to which ASR server can assign a mobile device user based on the side information include public locations such as stores, shopping malls, railway stations, and airports.

ASR Server 112 returns the text corresponding to the voice search request, and any categories it is able to extract from side information to transaction server 110 over connection 126.

### Interaction between the Transaction Server and the Content Provider

Transaction server 110 selects one or more content providers 114a,b,c to service the search request. It uses the category of the search, if that is known, either explicitly via a guided gate search command, or from automatic category detection on ASR Server 112 to guide its selection. For example, if the search is for ringtones, the transaction server passes the request to a ringtone provider, such as a server of the wireless carrier. As another example, if the search is a sports news request, it passes the request to an ESPN server. When it receives text corresponding to an uncategorized search, it performs some editing on the search string, such as removing prepositions and articles, and transmits it to a general-purpose content provider, such as Google. Transaction server 110 can also use the metadata to affect its selection of content provider(s) to service the search request.

Transaction server 110 also can transmit some of the metadata to the content provider. The metadata helps the content provider to return results that are better targeted to the user. For example, if the user is searching for clothing stores, and the system has determined that the user is female, then the content provider uses this information to prioritize its results on women's clothing stores. Since this information is determined implicitly from the audio stream without the need to ask the user any questions, it differentiates voice-mediated searches from text-mediated ones. As another example, the system can use its knowledge of the make and model of device 102 and the home residence of the user to make demographic inferences about the user. For example, if the user owns an expensive, high-end mobile device and lives in a wealthy neighborhood, he is probably of above average income. The content provider(s) can use such demographic inferences to better target responses to the mobile voice search request.

Content provider(s) 114a, b, c return search results via connection 132 to transaction server 110. The search results include items that are responsive to the search request. The returned items are also responsive to any metadata that transaction server 110 sent to the content providers along with the search request. The transaction server analyzes the content in an attempt to determine a category of search from the type of returned content. One method involves searching for key words in the results. If it is able to determine a category, it invokes special purpose software that formats the results in a manner that is appropriate to that content. Screen display 302 (FIG. 3) illustrates an example of specialized formatting that displays a map in response to a search for a particular type of business in a specific location.

Even if transaction server is unable to determine a search category by inspecting a generic search result, it “scrapes” the results by extracting underlined or bolded portions of a result page and phone numbers. For results from generic content providers, such as Google, the transaction server displays a small number of the top-ranked results and as much text as can be presented legibly and attractively on the display of mobile device 102.

In some cases, the voice search provider has a business relationship with the content provider, and receives interface information that allows the transaction server to extract the appropriate user-requested information for display on the mobile device.

Transaction server 110 uses metadata, both explicit and implicit (side information) to select and prioritize the content it receives from content providers 114. If it sent no metadata to content provider(s) 114a,b,c, it receives the same results from the content providers that a normal text search would provide. In this case, the transaction server alone (and not the content providers) adds value to the search results by using the metadata to optimize the value of the results to the user. By combining knowledge derived from the search query text, the search result content, and the metadata, the transaction server can return highly sifted, targeted results to the user. If the user finds such results valuable, he will be more likely to use voice-mediated search frequently, which in turn provides a greater number of opportunities to transmit a revenue-producing advertisement to the user.

### Interaction with Advertising Providers

Transaction server 110 transmits the text of the search command, and optionally the search results and some or all of the metadata to one or more advertising providers 116a,b,c over connection 134. Advertisement providers respond by offering advertisements along with pricing information back to transaction server 110 over connection 136. The metadata provides advertisers with more information about the user than they are able to get from text-based searches. This information enables them to select advertisements that are more effectively targeted to the user than the advertisements they would select in the absence of the metadata. The voice search provider selects the advertising providers and specific advertisements based on a variety of factors, including the pricing information, any business relationships with advertisers, or other commercial information.

The transaction server maintains a log of the user's query history, and of the user's response to advertisements and to items contained within the search results. It can share this information with advertisers in order to provide more information upon which to base the selection of one or more advertisements to display along with subsequent search results that respond to subsequent search requests.

### Returning the Results to the Mobile Device

After transaction server receives search results from the content providers and any advertisements from the advertising providers, search management software 118 selects the items of information, including both search results and advertisements, that transaction server 110 sends over the wireless data channel 138 to mobile device 102. This selection is based on such factors as: the degree of responsiveness of items within the search results to the category of the search request and to the user category as determined from side information; the degree of targeting of the advertisements to the user category; and the relevance of the advertisements to the search request. One selection method involves limiting the selection sent to the mobile device only to those search result items that have a degree of responsiveness greater than a threshold degree of responsiveness. The search management software sets the threshold in order to limit the number of search result items to a number that can be legibly and attractively displayed on the mobile device. The user or the operator of the transaction server can also adjust the threshold manually.

Search management software 118 can also prioritize items within the search results according to the factors listed in the previous paragraph. For example, if the user category is female and the search is for clothes, the search management software assigns a higher priority to search result items relating to women's clothes than to men's clothes. It uses the degree of responsiveness of each search result item to the search request in light of the user category to rank order the results. It then tags each items among the search results that exceed the threshold degree of responsiveness with a rank number. The mobile device can then display the received search result items in rank order, with the most responsive result at the top of the list of displayed results.

After selecting items contained within the search results and one or more advertisements, transaction server 110 sends its selection to mobile device 102 via wireless data connection 138. It formats the display to make it as legible and/or presentable as possible for display on device 102. The results can be multimodal, i.e., include text, graphics audio, and video. Transaction server 110 transmits the combined search results and advertisements to the phone over connection 138 via the wireless carrier.

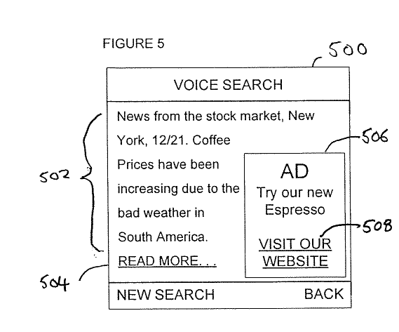

VMSA 106 on device 102 receives the results from the transaction server, and presents them to the user. FIG. 5 shows an example of a displayed search result 500 that includes content 502 with an option 504 to receive additional content on subsequent screens. It also includes an advertisement that also contains an option 508 to provide more information about the advertiser's products.

When the user of mobile device 102 receives search results and advertisements as a result of a search request, he may use one or more of the items among the search results to connect to a remote resource. He initiates such connections by clicking on a link contained within one of the received search results or advertisements, by placing a phone call to one of the resources identified in a search result or advertisement, or by using other input means provided on mobile device 102.

Device 102 maintains a log of the actions the user takes in response to receiving the search results. Among the items logged are all user actions that involve initiating a connection between mobile device 102 and a remote resource, whether or not such connections involve transaction server 110. Such connections can be achieved via wireless data connection 108, or over other wireless or fixed connections, such as Wi-Fi connections and telephone lines.

VMSA 106 sends the information contained within the log to transaction server 110, thus providing important feedback to the transaction server on how useful and responsive the search results are for the user. Receiving the log also provides valuable information on the effectiveness of the sent advertisements. In a typical mode of operation VMSA 106 stores the log on mobile device 102, and sends the log to the transaction server at regular intervals. Alternatively, VMSA 106 sends the contents of the log to the transaction server at a time triggered by one or more user connections to remote resources. The timing and frequency of sending the log to the transaction server is determined by VMSA 106, but this can be adjusted by the provider of mobile search services via search management software 118 using, for example, connection 138 from transaction server 110 to communicate with mobile device 102.

The transaction server uses the log information to gain a measure of how valuable particular items among the search results are to the user. It can use this measure to help improve its selection of search results when it responds to subsequent search requests from the user of the mobile device. Such improvements make the search results more responsive to the user, which encourages the user to perform further searches. If the log contains an indication that the user responded to one or more advertisements, the transaction server gains valuable information on the effectiveness of the advertisements. This information is used to help search management software 118 select effective advertisements from the set of advertisements it receives from advertising providers 116a,b,c. It also uses the logged information to determine the allocation of revenue/billing among the parties involved, such as the mobile search provider, the content provider, and the advertiser, as well as to rate the effectiveness of a particular advertisement.

When a user responds to an advertisement by making a phone call or selecting an internet link to an advertiser's web page, VMSA 106 can connect device 102 directly to the advertiser. This connection does not involve any of content providers 114a,b,c that supplied the search result content to the transaction server and need not involve the transaction server. This process contrasts with the traditional advertisement click-through sequence in which the user is first transferred to the content provider, which then logs the click-through, and forwards the request on to the advertiser. VMSA 106 logs the user action and transmits it to transaction server 110 immediately or at a later time. The transaction server then allocates revenues and billing according to a commerce model that is based on the business relationship among the relevant parties.

VMSA 106 and/or voice search management software 118 can cause a phone number or link from an advertisement to be stored locally on device 102 at the user's option. VMSA 106 stores the phone numbers in the user's local phone book or as an entry in his personal yellow pages, which are described below. VMSA 106 stores links to advertiser-sponsored web pages in the user's yellow pages, or in another data structure on device 102 set up by VMSA 106 for this purpose. VMSA 106 logs such actions, and later transmits the log to the transaction server. Voice search management software 118 can charge the advertiser a fee each time the user stores an advertised phone number or link in device 102.

### Personal Yellow Pages

As a user builds up a track record of searches with device 102, VMSA 106 recognizes searches that are made more than a predetermined number of times. For example, if the user frequently requests the phone number of his favorite Italian restaurant, device 102 retains the search string, the search results, and the recognized speech pattern locally. Next time the user requests the number, the phone is able to fulfill the search request locally. Voice searches that can be fulfilled just by using the device's own speech recognizer and content stored on the device provide several advantages to the user. First, the response is faster because there is no latency associated with opening up a data connection and communicating with a remote server. Second, the user does not need to use wireless bandwidth, which is a scarce commodity for which he is billed. Third, locally stored information is available to the user even when there is no wireless phone service is available, as might occur in a tunnel or in a remote location.

VMSA 106 determines whether a particular search request has been received enough times and/or at sufficiently short intervals to warrant local storage of search results and, optionally, to store speech recognition information related to that search request on mobile device 102. Default criteria for determining when to store a search result locally are included with VMSA 106 when mobile device 102 is shipped from the factory. However, if desired, either the user or the provider of mobile search services can adjust the criteria. For example, the criteria for local storage can be relaxed when the amount of memory on the mobile device is increased, which places fewer constraints on the volume of data that can be stored on the device.

The user of the mobile device can instruct his device to store the results of any particular search request, even if the request has not been made previously. The user can also retrieve any locally stored search results by requesting the results using a keypad or soft keys on device 102, or using a graphical input device. Thus, although it may often be more convenient for the user to perform searches that can be fulfilled using locally stored search results using a spoken search request, other means that are not voice-mediated of inputting a search request are available to him.

In order to recognize search requests for which VMSA 106 stores results locally, the mobile device requests speech recognition information corresponding to such search requests from transaction server 110. Alternatively, search management software 118 recognizes that device 102 has sent certain search requests more than once, and it determines whether and when to send speech recognition information corresponding to these repeated requests. In either case, the result is that the mobile device becomes capable of recognizing such repeated requests without the need for an external connection.

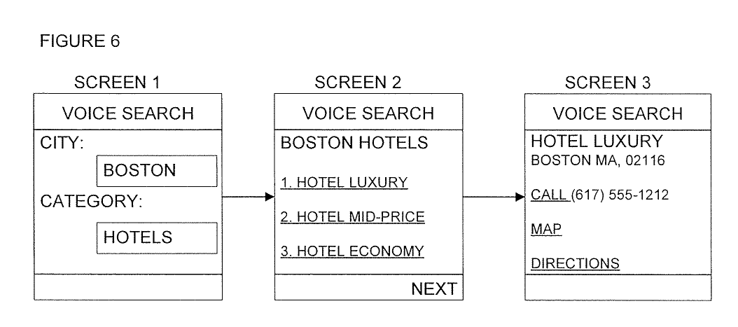

The information corresponding to the locally stored search results is indexed by the search category uttered by the user. For example, if the user frequently asks his device to “SEARCH BOSTON HOTELS” the device stores the results under an index entry “Boston Hotels.” FIG. 6 illustrates a series of screens that result from local speech recognition of the command “Boston Hotels,” and subsequent guided dialog and stored data, without accessing a remote server. Only in the final screen, if the user clicks the displayed links or otherwise seeks more information, does VMSA 106 open connection 108 to the transaction server and a content provider to retrieve the additional information.

VMSA 106 also indexes locally stored search results by geographical location, such as by country, state, and city. It can also index the local search results by the type of business to which it pertains. Thus locally stored information is analogous to a combination of personal yellow pages and business white pages additional indexing schemes, including a scheme corresponding to the user's personal search terms. The user can access the information directly by requesting search results corresponding to any of the indices, i.e., by using his own previously used search term, the geographical location, or the type of business in any combination. Other indexing schemes can also be added, as appropriate, for various types of search and their corresponding search results.

Device 102 also recognizes past patterns of user searching to pre-load data that it may need to fulfill a future search request. For example, if the user often requests “SEARCH RED SOX SCORES,” the device 102 will regularly receive Red Sox scores from a sports content provider via transaction server 110. The wireless network carrier can provide this low bandwidth service at no additional cost by using off-peak transmissions to device 102. Preloading of data enables the mobile device to provide up-to-date search results without the need for an external connection when it receives the corresponding search request. This is especially valuable when the search requests time-sensitive information, such as weather conditions, traffic conditions, and sports results.

The user of device 102 may choose to share his locally stored yellow pages with users of other devices, and conversely, receive others' yellow pages. This feature is especially useful when the user travels to a new location and is not familiar with businesses and services in that location. If the user knows the other person, this “social networking” offers a convenient means of receiving information from a trusted source. Social networking may be pairwise, or involve groups who provide permission to each other to share personal yellow pages. Users can augment the entries in their locally stored yellow pages with reviews, ratings, and personal comments relating to the listed businesses. Users can choose to share this additional information as part of their social networking options.

### Mobile Device Platform

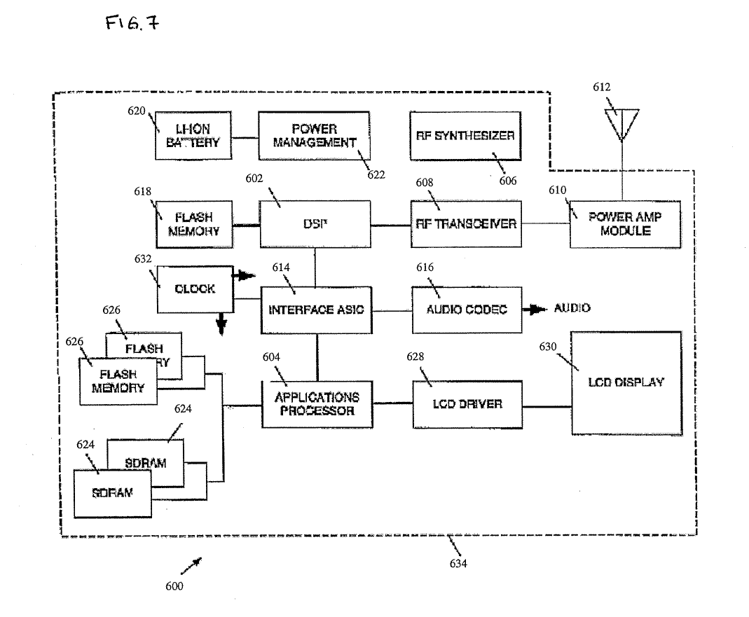

A typical platform on which mobile communications device 102 can be implemented is illustrated in FIG. 7 as a high-level block diagram 600. The device includes at its core a baseband digital signal processor (DSP) 602 for handling the cellular communication functions, including, for example, voiceband and channel coding functions, and an applications processor 604, such as Intel StrongArm SA-1110, on which the operating system, such as Microsoft PocketPC, runs. The device supports GSM voice calls, SMS (Short Messaging Service) text messaging, instant messaging, wireless email, desktop-like web browsing along with traditional PDA features such as address book, calendar, and alarm clock. The processor can also run additional applications, such as a digital music player, a word processor, a digital camera, and a geolocation application, such as a GPS.

The transmit and receive functions are implemented by an RF synthesizer 606 and an RF radio transceiver 608 followed by a power amplifier module 610 that handles the final-stage RF transmit duties through an antenna 612. An interface ASIC 614 and an audio CODEC 616 provide interfaces to a speaker, a microphone, and other input/output devices provided in the phone such as a numeric or alphanumeric keypad (not shown) for entering commands and information, and hardware (not shown) that supports a graphical user interface. The graphical user interface hardware includes input devices such as a touch screen or a track pad that is sensitive to a stylus or to a finger of a user of the mobile device. The graphical output hardware includes a display screen, such as a liquid crystal (LCD) display or a plasma display.

DSP 602 uses a flash memory 618 for code store. A Li-Ion (lithium-ion) battery 620 powers the phone and a power management module 622 coupled to DSP 602 manages power consumption within the device. The device has additional hardware components (not shown) to support specific functionalities. For example, an image processor and CCD sensor support a digital camera, and a GPS receiver supports a geolocation application.

Volatile and non-volatile memory for applications processor 614 is provided in the form of SDRAM 624 and flash memory 626, respectively. This arrangement of memory can be used to hold the code for the operating system, all relevant code for operating the device and for supporting its various functionality, including the code for the speech recognition system discussed above and for any applications software included in the device. It also stores the speech recognition data, search results, advertisements, user logs, personal yellow pages data, and collections of data associated with the applications supported by the device.

The visual display device for the device includes an LCD driver chip 628 that drives an LCD display 630. There is also a clock module 632 that provides the clock signals for the other devices within the phone and provides an indicator of real time. All of the above-described components are packaged within an appropriately designed housing 634.

Since the device described above is representative of the general internal structure of a number of different commercially available devices and since the internal circuit design of those devices is generally known to persons of ordinary skill in this art, further details about the components shown in FIG. 7 and their operation are not being provided and are not necessary to understanding the invention.

The servers mentioned herein can be implemented on commercially available servers that include single or multi-processor systems, conventional memory subsystems including, for example, disk storage devices, RAM, and ROM.

Other aspects, modifications, and embodiments are within the scope of the following claims.

What is claimed is:

1. A method implemented on a mobile device that includes speech recognition functionality, the method comprising:
receiving an utterance from a user of the mobile device, the utterance including a spoken search request;
using the speech recognition functionality to recognize that the utterance includes a spoken search request;
sending a representation of the spoken search request to a remote server over a wireless data connection;
receiving search results over the wireless data connection that are responsive to the search request;
storing the search results on the mobile device;
receiving a subsequent search request;
performing a subsequent search responsive to the subsequent search request to generate subsequent search results, wherein the subsequent search includes searching the stored search results; and
presenting the subsequent search results on the mobile device.

2. The method of claim 1, further comprising receiving a plurality of search requests, wherein the first-mentioned spoken search request is one of the plurality of received search requests, and the plurality of search requests is used to establish a popularity of each of the plurality of search requests.

3. The method of claim 2, further comprising:
receiving speech recognition information to enhance an ability of the speech recognition functionality to recognize the subsequent search when the subsequent search request is a spoken search request and when the subsequent search request corresponds to a last-received search request of the plurality of search requests; and
storing the received speech recognition information on the mobile device.

4. The method of claim 2 further comprising:
for a last-received search request of the plurality of search requests, determining whether the last-received search request exceeds a predetermined threshold popularity of search request; and
if the last-received search request exceeds the predetermined threshold popularity of search request, storing search results corresponding to the last-received search request on the mobile device.

5. The method of claim 4 further comprising:
if the last-received search request exceeds the predetermined threshold popularity, receiving speech recognition information to enhance an ability of the speech recognition functionality to recognize the last-received search request when the last-received search request is a spoken search request; and
storing the received speech recognition information on the mobile device.

6. The method of claim 2, further comprising:
prior to receiving the subsequent search request, receiving information responsive to the subsequent search request;
storing the received information on the mobile device to enhance the responsiveness of the mobile device to the subsequent search request; and wherein
the subsequent search includes searching the stored received information.

7. The method of claim 6, wherein the received information responsive to the subsequent search request is time-sensitive, and the enhanced responsiveness of the mobile device to the subsequent search request involves enhancing an ability of the mobile device to present up-to-date search results.

8. The method of claim 1, wherein the subsequent search results are retrieved from the stored search results.

9. The method of claim 1, wherein at least one of the stored search results is assigned to a category and generating the subsequent search results includes retrieving stored search results that have been assigned to the category.

10. The method of claim 9, wherein the category corresponds to the spoken search request.

11. The method of claim 9, wherein the category corresponds to a geographical location associated with the at least one stored search result.

12. The method of claim 9, wherein the category corresponds to a type of business associated with the at least one stored search result.

13. The method of claim 9, wherein the at least one stored search result is assigned to a plurality of categories, and wherein the first-mentioned category is one of the plurality of categories.

14. The method of claim 1, wherein the subsequent search request is a spoken search request and the subsequent spoken search request is recognized using the speech recognition functionality.

15. The method of claim 1, wherein the mobile device includes input keys, and the subsequent search request is received via the input keys.

16. The method of claim 1, wherein the mobile device includes hardware that supports a graphical user interface, and the subsequent search request is received via the graphical user interface.

17. A mobile device that includes a processor system and memory storing code which when executed by the processor system causes the mobile device to perform the functions of:
receiving an utterance from a user of the mobile device, the utterance including a spoken search request;
using speech recognition functionality to recognize that the utterance includes a spoken search request;
sending a representation of the spoken search request to a remote server over a wireless data connection;
receiving search results over the wireless data connection that are responsive to the search request;
storing the search results on the mobile device;
receiving a subsequent search request;
performing a subsequent search responsive to the subsequent search request to generate subsequent search results, wherein the subsequent search includes searching the stored search results; and
presenting the subsequent search results on the mobile device.

18. The mobile device of claim 17, wherein the subsequent search results are retrieved from the stored search results.

19. The mobile device of claim 17, wherein the code when executed on the processor system further causes the mobile device to perform the function of assigning at least one of the stored search results to a category and generating the subsequent search results includes retrieving stored search results that have been assigned to the category.

20. The mobile device of claim 19, wherein the category corresponds to the spoken search request.

21. The mobile device of claim 19, wherein the category corresponds to a geographical location.

22. The mobile device of claim 19, wherein the category corresponds to a type of business associated with the at least one stored search result.

23. The mobile device of claim 19, wherein the at least one stored search result is assigned to a plurality of categories, and wherein the first-mentioned category is one of the plurality of categories.

24. The mobile device of claim 17, wherein the subsequent search request is a spoken search request and the code when executed on the processor system further causes the mobile device to perform the function of recognizing the spoken search request.

25. The mobile device of claim 17, wherein the mobile device includes input keys and the code when executed on the processor system further causes the mobile device to perform the function of receiving the subsequent search request via the input keys.

26. The mobile device of claim 17, wherein the mobile device includes hardware that supports a graphical user interface and the code when executed on the processor system further causes the mobile device to perform the function of receiving the subsequent search request via graphical user interface.
